(19) United States
(12) Patent Application Publication
(10) Pub. No.: US 2010/0045147 A1
(43) Pub. Date: Feb. 25, 2010

(54) Modular Storage System for Laboratory Fluids

(76) Inventors: Kurt Harnack, Tangstedt (DE); Helmut W. Knofe, Norderstedt (DE); Jeans-Peter Kroog, Grosshansdorf (DE); Peter Scheffler, Hamburg (DE)

Correspondence Address: WHITE & CASE LLP;PATENT DEPARTMENT, 1155 AVENUE OF THE AMERICAS, NEW YORK, NY, 10036, US

(21) Appl. No.: 12/306,026

(22) PCT Filed: Jul. 4, 2006
(86) PCT No.: PCT/EP06/06508

§ 371 Date: Oct. 19, 2009

(30) Foreign Application Priority Data
Jun. 29, 2006 (EP) 06116269.9

(51) Int. Cl. A47B 87/00; B01L 9/00

(52) U.S. Cl. 312/107; 901/31

(57) ABSTRACT

According to the invention, a modular storage system for laboratory fluids is characterized in that a carrier frame comprises a defined number of slots for at least two different laboratory vessel inserts, which can be inserted so that they can be arbitrarily interchanged and inserted in arbitrary combinations with a positive fit in the slots of the carrier frame and which each comprise at least one laboratory vessel and/or at least one compartment for at least one laboratory vessel.

The present invention relates to a modular storage system for laboratory liquids.

Previously known systems for storing samples are primarily fitted to specific analysis equipment with the object of achieving a sample throughput which is as high as possible. In particular, they are known in the field of clinical analysis equipment. The object achieved in this case is to hold as many samples as possible, to store them, to organize them and to keep them available for analysis purposes. These systems have a correspondingly complex design. Particularly in these systems, the integration in complex analysis steps which run as quickly as possible is intended to be achieved without contamination. There is also special emphasis on the need to avoid evaporation of reagents, which can be very expensive, by sealing the reaction vessels.

For example, corresponding embodiments can be found in U.S. Pat. No. 4,933,146. Here, sealed cuvettes with an identical design are used in an annular arrangement in the presence of an active heating and cooling device as components of a mechanism for identifying signals.

The object is achieved in a similar vein in EP 0 651 254 A1. The individual reagent kit required for clinical analysis equipment is placed, in a linear arrangement in a container which can be cooled, onto a cooling system equipped with Peltier elements.

Another object from the medical field is achieved in US 2006/0012773 A1. In accordance with this invention, biological objects from laser microdissection are stored in an array of identical vessels.

So as to satisfy the clinical demands regarding the identifiability of samples, means for identifying samples in clinical analysis equipment in particular are considered, such as barcode or mechanical scanning systems as disclosed in U.S. Pat. No. 6,432,359 Bi or U.S. Pat. No. 5,672,317, for example. In particular embodiments, all the product information of a sample system is even taken into account (U.S. Pat. No. 5,589,137).

Apparatuses for automated high throughput, such as DE 103 33 545 A1, are more recent developments. In this case, as many samples as possible which relate to the same object are arranged and inserted into identical vessels in a cartridge system comprising three levels.

Another embodiment is found in U.S. Pat. No. 5,788 929. It primarily relates to the transport and processing of portable samples, in which the sample is intended to be kept below the ambient temperature without the need for regulation.

Other cases, such as those disclosed in U.S. Pat. No. 6,156,275 or PCT WO 00/45953, provide a very complex solution for the reception mechanism for vessels for reasons of automation.

The applications described are primarily technically complex solutions for suitably storing usually identical types of samples for a long time in order to analyze them, for temporarily making them available for an analysis machine, and for returning them to their starting position. The system for storing liquids in this case requires the same type of vessels.

However, general laboratory work primarily has different objectives. Modern workstations are used for programmed handling of liquids in the laboratory and are designed in a space-saving fashion. Their objectives are not routine problems such as storage, clinical analysis and/or high throughput. This different set of problems requires constantly changing the equipment of work modules to have, for example, liquid handling stations, vacuum chambers, thermal cyclers for PCR (polymerase chain reaction), centrifuges, array spotters or other instruments.

The object of the invention is to develop a storage system for liquids or other substances in a constantly changing work environment which is flexible, space-saving, cost effective, preferably temperature-controlled, portable and suitable for a multiplicity of different types of vessels and other containers.

According to the invention, this object is achieved by a modular storage system having the features of claim 1. Preferred refinements are specified in the dependent claims.

According to the invention, a modular storage system for laboratory liquids has a carrier frame and at least two different laboratory vessel inserts which can be inserted into the carrier frame such that they can be interchanged and combined arbitrarily. For this purpose, the carrier frame has a certain number of slots which are tailored to this object in their design for the purposes of a form fit with the laboratory vessel inserts. The laboratory vessel inserts themselves each have at least one laboratory vessel integrated directly, and/or have at least one compartment for at least one separate laboratory vessel. This makes it possible for the storage system according to the invention to house both conventional laboratory vessels and vessels which are, for example, specifically adapted in their volume or geometry for a certain application. It is also possible for laboratory vessels which will be available on the market in future to be integrated in the storage system by then constructing laboratory vessel inserts for this purpose which have a correspondingly adapted compartment.

The storage system according to the invention can easily be embedded into the work surroundings and programs of a computerized workstation for the laboratory. In particular, according to the invention it is advantageous that a multiplicity of laboratory containers can be chaotically integrated in the reception apparatus, with the containers respectively differing in shape, diameter size, height, material and design of the seal. The high interaction capabilities of modern workstations are supported by the possible automatic identification of the storage system according to the invention with regard to position, alignment and type of system components. The samples can be kept at a target temperature in order to impede the evaporation of the often very valuable substances, for example, and not impair their stability. It is for this reason that it is advantageously possible to integrate a temperature-control device into the overall system.

It is the object of the invention to provide an apparatus in the form of a modular storage system, which can preferably be temperature-controlled, which permits, in a small space, the simultaneous reception of very different laboratory vessels or other containers with very different shapes, diameters and heights. The vessels can freely and independently of one another be inserted into the modular storage system so that the overall space available is used in an optimum manner. In particular in automated workstations in laboratory work, this achieves access to very many types of vessel with it simultaneously being possible to control the temperature.

In many laboratory processes, it is unavoidable that storage is connected to cooling, heating and stabilizing the temperature of liquids and other substances. In many cases, a large number of very different containers for samples have to simultaneously be handled in the smallest possible space. The invention finally permits an optimum implementation of these objectives. Here, the term container comprises all objects used in the laboratory to accommodate solid or liquid substances.

The storage system according to the invention can be arranged in a temperature-control device integrated in a workstation. The storage system comprises a module rack which preferably houses different temperature-control modules. Each temperature-control module preferably has a multi-functional insertion aid at its upper end and holds the containers which are to be temperature-controlled. Preferably, the storage system is, overall or in parts, autoclave safe.

In this case, the term temperature-control module relates to laboratory vessel inserts according to the invention with a body comprising a thermally conductive material which at least in part surrounds the at least one laboratory vessel of the insert. This body is preferably planar on its underside, and the underside of the body of the inserts, which are inserted in the carrier frame, protrude from the frame such that they together form a preferably planar underside. This underside then forms the contact surface with the temperature-control surface of a temperature-control device. However, according to the invention, it is also feasible that the module undersides return into the carrier frame if the temperature-control device in turn has a fitting temperature-control surface. It is particularly preferable for the modules to be slightly lifted by the temperature-control surface of the temperature-control device when the carrier frame is inserted into the temperature-control device, so that the surface contact between the temperature-control surface and the underside of the modules is ensured in particular by the latter's own weight.

The term temperature-control device correspondingly comprises all apparatuses used in the laboratory with planar or other surface shapes for attaining the required thermal transmission. Preferably, the temperature-control device can be manufactured from aluminum, silver or other metals or alloys. Alternative materials include highly conductive plastics and coating substances, which, for example, include nanoparticles.

Due to the optional arrangement of the temperature-control modules in the module rack, it is possible to accommodate very many different containers in a spatially optimum manner. The samples in the containers are brought to a desired temperature or temperature profile by thermal conduction via the thermal contact of the temperature-control modules with the temperature-control device.

The temperature-control device is preferably installed in a workstation such that, by means of a suitable, for example interlocking, reception apparatus, the storage system or parts thereof can be placed onto the temperature-control device in an interlocking fashion manually or by means of a suitable robotic transport device. The temperature and temperature profile can be programmed by the control unit of the workstation, for example.

The module rack preferably comprises a cuboid mount (carrier frame) which is made from one piece and is open at the top and bottom. Alternatively, multi-part shapes are also feasible. The format of the base used is preferably compatible with the format of one or more connected microplates (SBS). Published standards for microplates of the Society for Biomolecular Screening (SBS) are, for example, ANSI/SBS 1-2004, ANSI/SBS 2-2004, ANSI/SBS 3-2004, and ANSI/SBS 4-2004. The SBS deals with standardizing microplates in order to in particular ease developments in laboratory automation and offer increased safety to the user.

The part of the module rack facing the temperature-control device preferably comprises corresponding reception elements for positioning the module rack with respect to the temperature-control device. The upper part of the module rack preferably comprises incisions for the interlocking and centering reception of the temperature-control modules, in particular by means of the multi-functional insertion aid. The module rack is equipped with indices to identify its presence in the workstation and to identify its position. In a preferred embodiment, an optical reading device using laser diodes is used for identification in a workstation. However, it is also possible to use different methods for identification such as barcodes with an associated scanner, mechanical scanning systems, RFID tags with a reader or methods from optical image processing.

The temperature-control modules, preferably made of highly thermally conductive material or material with good heat storage, can have the multi-functional insertion aid on their upper side. The smaller sides of the multi-functional insertion aid preferably comprise positioning webs for interlocked fixing to the module rack. The temperature-control modules can preferably be manufactured from aluminum, silver or other material or alloys. Alternative materials include highly conductive plastics and coating substances, which, for example, include nanoparticles.

However, it is also possible for thermally insulating laboratory vessel inserts to belong to the system according to the invention. In this case, the laboratory vessels (or the compartments for them) are surrounded by an insulating material body which does not conduct heat well.

The positioning webs are preferably provided with indices or codes which permit identification of the respective type of temperature-control module. In a preferred embodiment, an optical reading device using laser diodes is also used to identify this in a workstation. However, in this case other methods of identification, such as barcodes with an associated scanner, mechanical scanning systems, RFID tags with a reader or methods from optical image processing, can also be used. In a preferred embodiment, the indices form elements which can be scanned optically, preferably in the form of circles or rectangles, or other shapes. Alternatively, raised or lowered structures can be used for mechanical scanning. Redundant coding is preferably used to avoid read errors. In a preferred embodiment, the lack of coding (“zero coding”) executes an interrupt routine in the program of the workstation which initiates corresponding steps for corrections, for example.

In a preferred embodiment, the coding on one of the positioning webs allows directionally oriented identification of the temperature-control modules in order to, for example, eliminate transposition of containers. In another embodiment, for example for test tubes with integral hinge lids, the positioning aid is provided with a cover fixing web. The fixing web comprises insertion openings to keep the cover of the test tubes open so that a defined approach of the vessel openings, in particular by automated pipettes, for example, is not hindered by the cover.

Preferably, the individual temperature-control modules are optimized with respect to their mass and shape such that a homogenous temperature distribution is obtained as quickly as possible. Mass optimization in a laboratory context is understood to mean structural features which, overall, optimize the benefits of heat transport and heat capacity. The shape optimization supports this process by the corresponding three-dimensional design.

The multi-functional insertion aid comprises openings for accommodating containers in the temperature-control module. The reception cavities of the temperature-control module can differ in height, diameter, distance and shape, depending on the shape of the vessel to be accommodated. They can also be open toward the bottom in order to support a cleaning or rinsing process, for example. Preferably, the heights of the reception cavities are dimensioned such that the inserted vessels protrude from the multi-functional aid and have flush edges. In a preferred embodiment, containers, which are to be accommodated and which have different lengths, can be aligned to have the same height at the top by means of lower stops which can be inserted on the side.

Preferably, the multi-functional insertion aid is also made from an autoclave safe material.

An alternative or complementary use of the storage system is the use as an independent storage system, even outside of a workstation, for example in cooling or freezing units, incubation units, for the intermediary storage of molecular-biological products, such as the temporary storage of amplification products or amplification reagents before, during or after a PCR process, for the temporary storage of proteins or antibodies or other products, or for the transport of containers between different workstations or within a workstation, or else in laboratory lines.

The temperature-control device for the system can be provided with additional functions in addition to the thermal function for the system, such as complementary apparatuses for shaking the storage system to ensure improved mixing of the samples in the containers. As a result of this, dissolving solids, such as tablets or material in a powdered form, is also supported, for example.

The module rack can also accommodate different modules for supporting processes in a laboratory, such as tubs for liquids or waste, instead of accommodating temperature-control modules. Other preferred embodiments of the laboratory vessel inserts or modules are, for example, vortex mixing inserts for relatively small laboratory tasks, or inserts for different electrical small-scale equipment for separating materials, for example such as for magnetic beads in purification of DNA.

The preferred embodiment of the module rack, and the components associated with it, has a cuboid shape. The underside of a preferred embodiment exactly fits into the microtiter plate format (SBS). However, it is also possible to use all other formats, such as circular forms, which are typically annular structures or carousels.

A preferred embodiment of the invention is described in an exemplary manner in the following text with reference to the attached drawings, in which

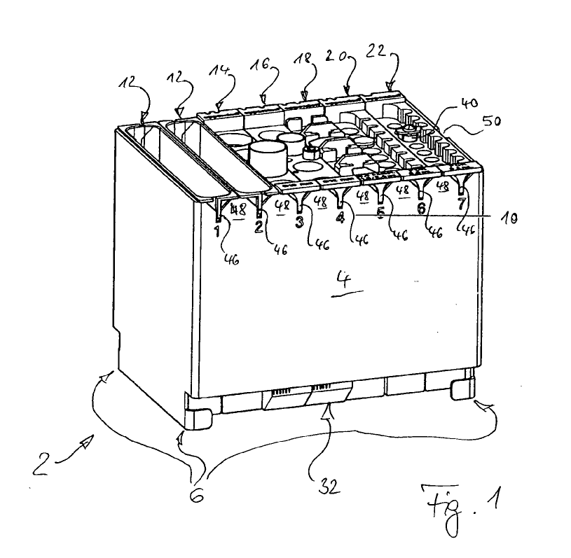

FIG. 1 shows a three-dimensional view of a modular storage system according to the invention for laboratory liquids with a carrier frame and seven laboratory vessel inserts,

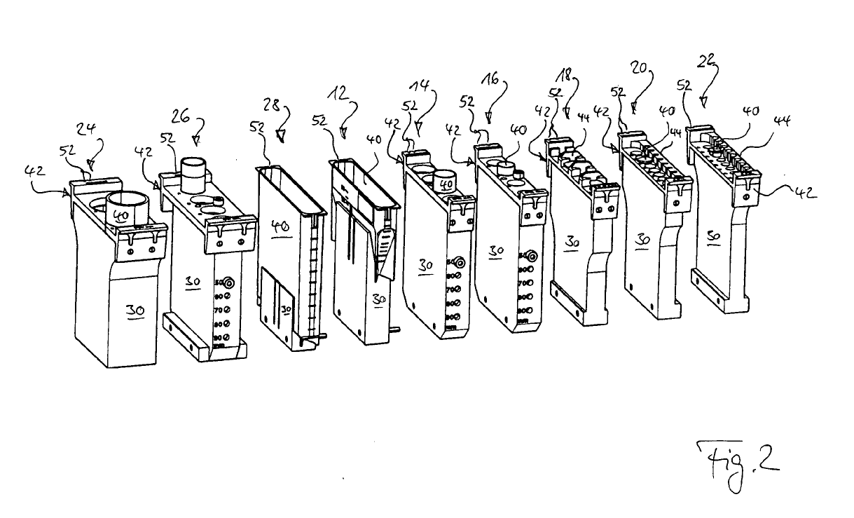

FIG. 2 shows a three-dimensional view of nine different laboratory vessel inserts, in part with laboratory vessels in the respective compartments,

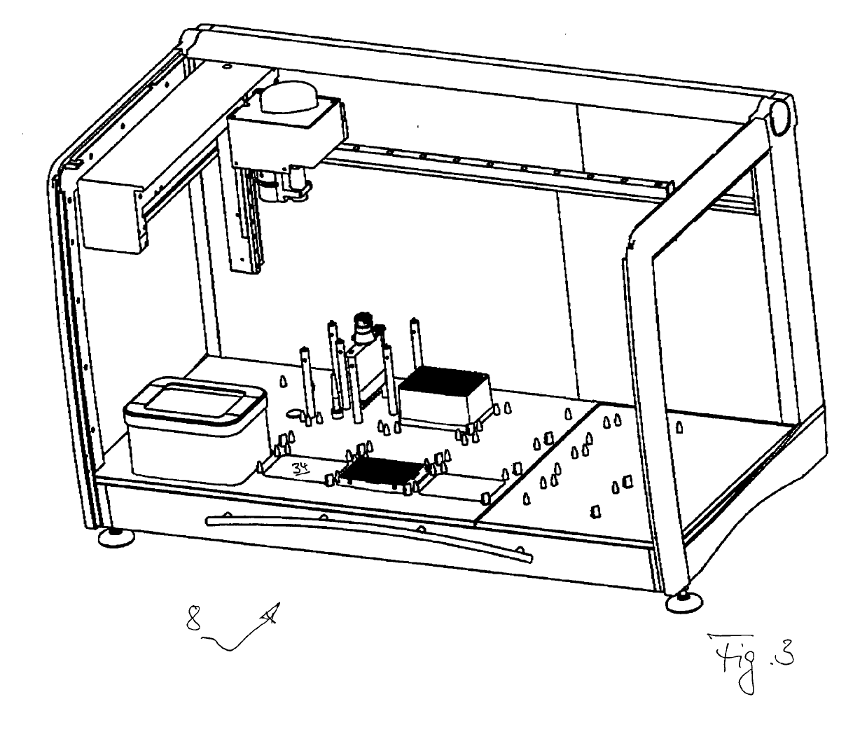

FIG. 3 shows a three-dimensional view of a workstation into which the storage system according to the invention (not illustrated) can be inserted,

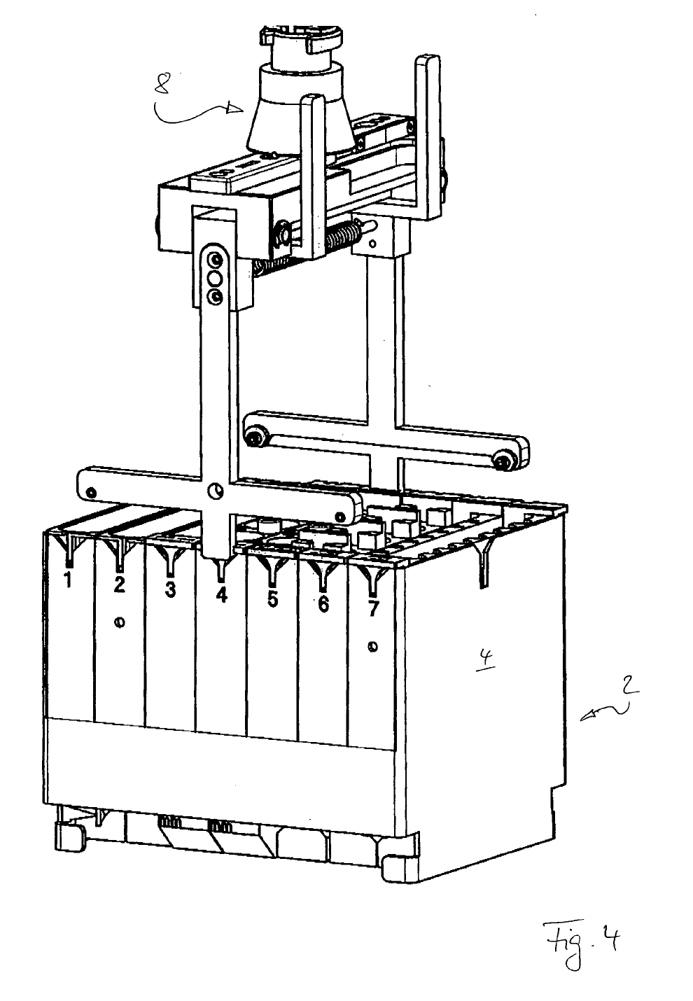

FIG. 4 shows the storage system according to the invention in accordance with FIG. 1, in a three-dimensional view, on a gripper of a workstation in accordance with FIG. 3, and

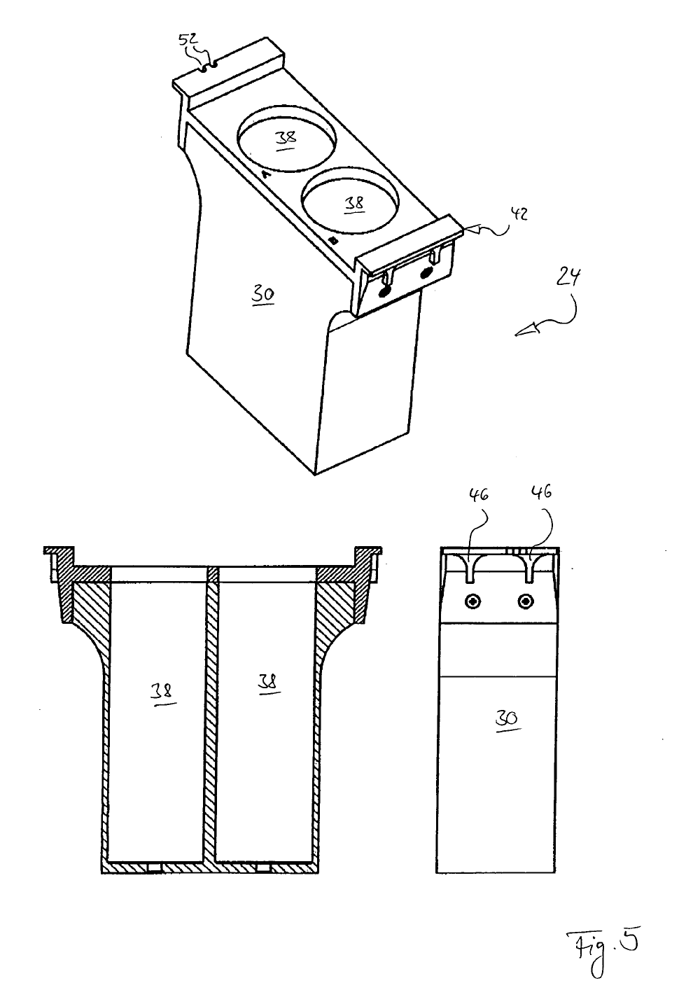

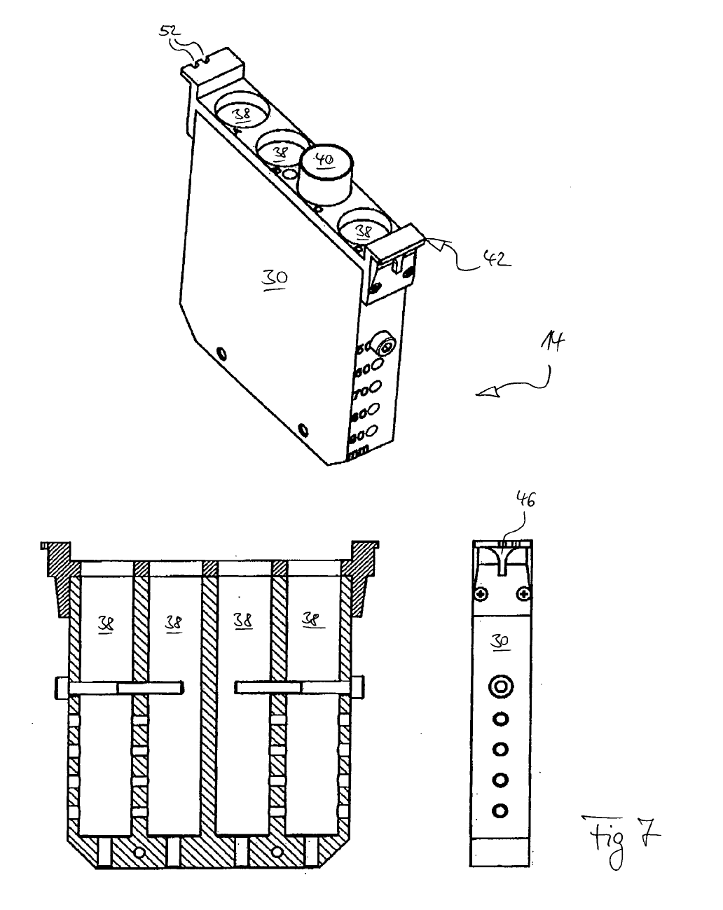

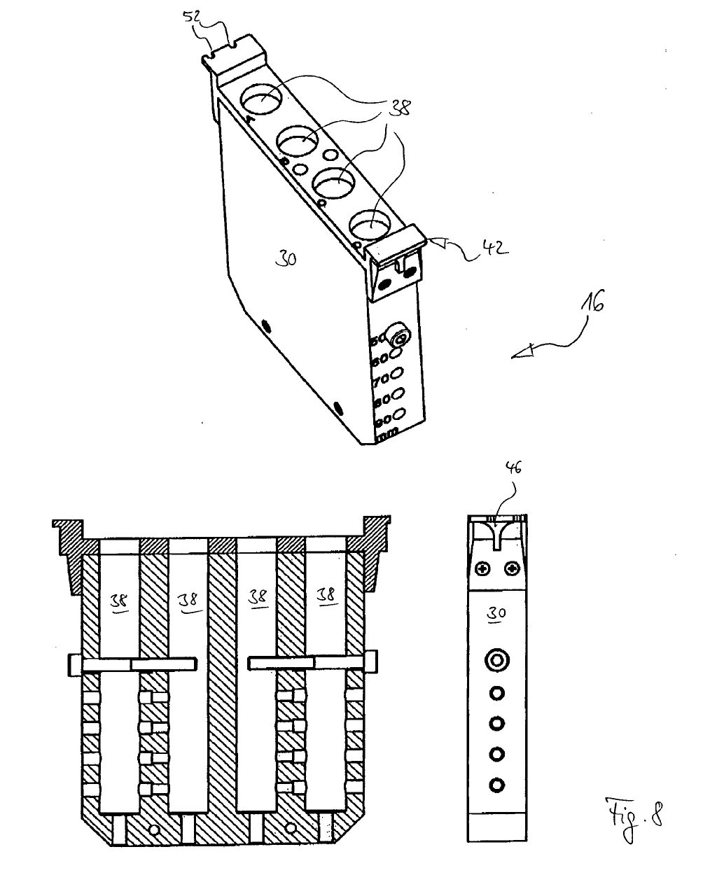

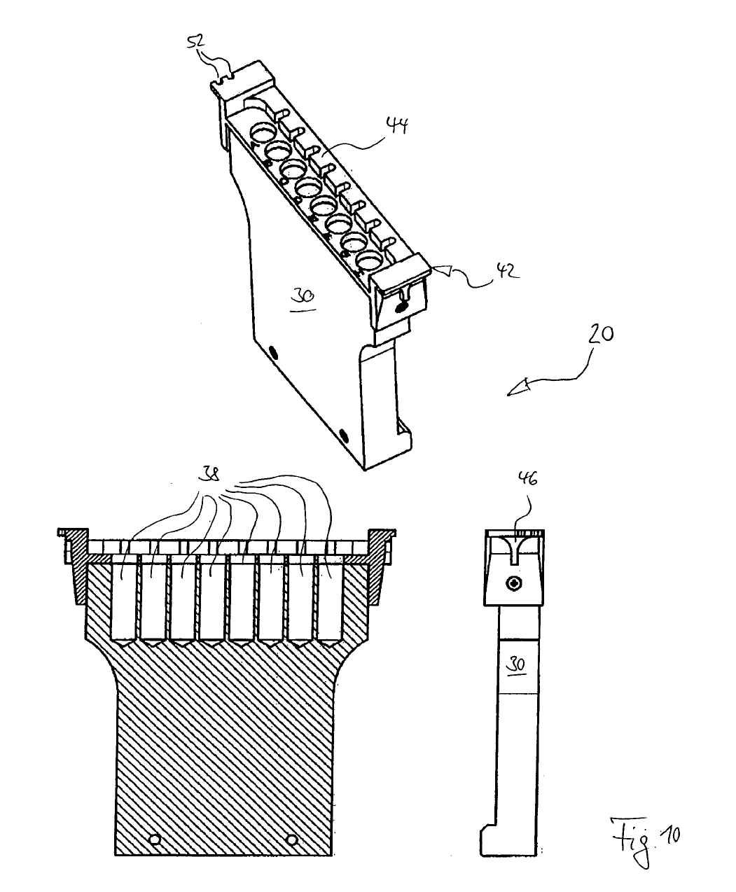

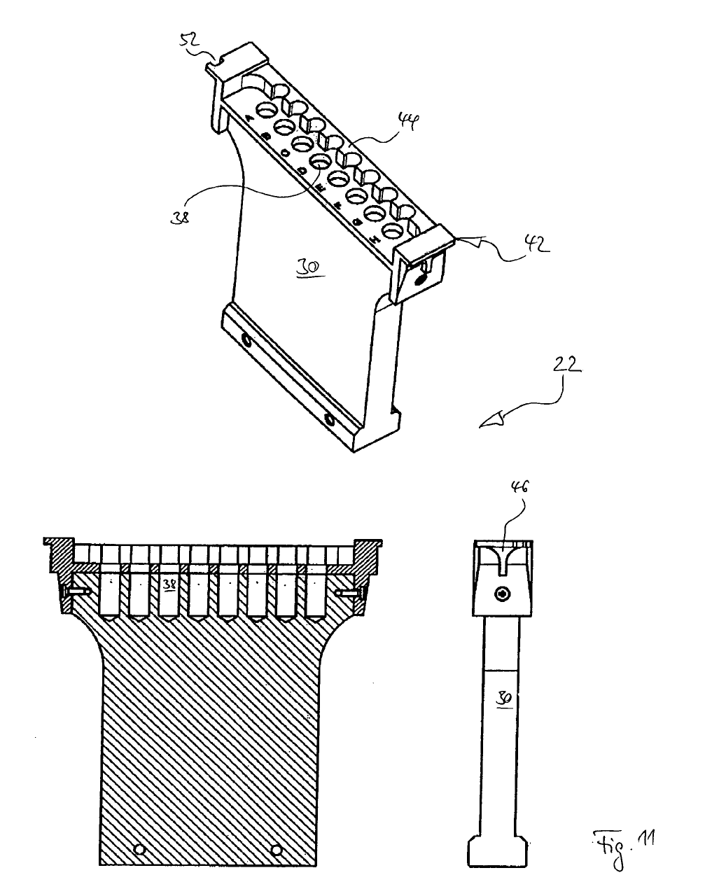

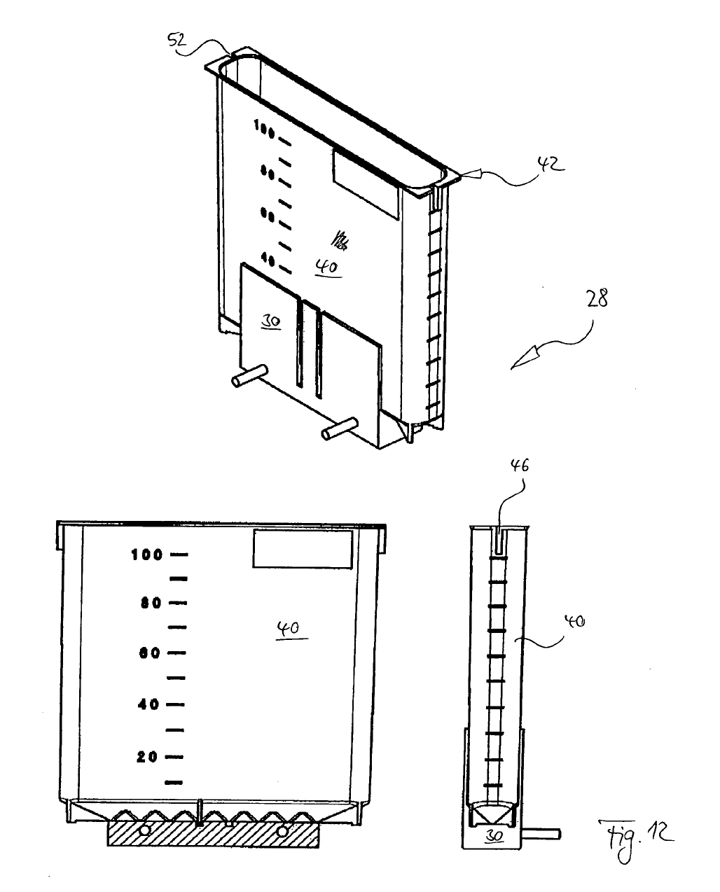

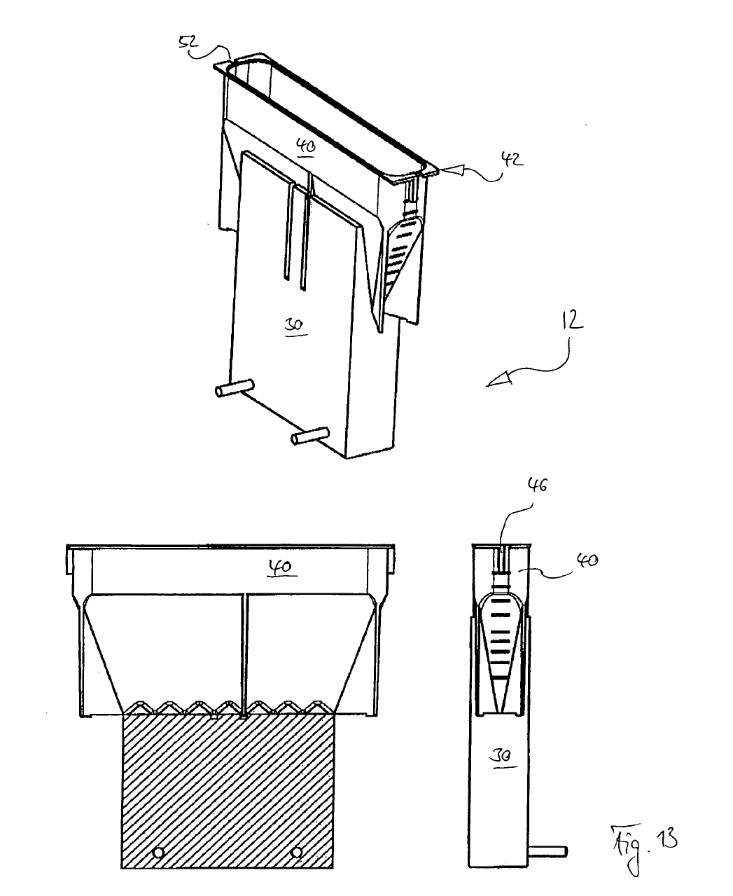

FIGS. 5 to 13 in each case show, in a three-dimensional view (top), in a cross section (bottom left) and in a side view (bottom right), the nine different laboratory vessel inserts in accordance with FIG. 2.

FIG. 1 shows a modular storage system 2 for laboratory liquids (not illustrated) with a carrier frame 4, which is bent from sheet metal. On the underside the carrier frame 4 has an SBS standard format of a microplate (6) . As a result of this, the carrier frame 4 can be inserted in an interlocking fashion into the different positions of, for example, a workstation 8 (FIG. 3), or else into other laboratory apparatuses provided for this connection measure.

The carrier frame 4, one again in accordance with FIG. 1, has a total of seven slots 10 for laboratory vessel inserts 12 to 22. The slots 10 numbered 1 and 2 are equipped in each case with identical laboratory vessel inserts 12 in the form of a low tub (cf. also FIG. 2), while the remaining slots 10, numbered 3 to 7, in each case are equipped with laboratory vessel inserts for in each case at least four laboratory vessels.

For the purposes of transportation within the workstation 8, both the carrier frame 4 and also the respective laboratory vessel inserts 12 to 28 have gripping structures so that the carrier frame with the inserted laboratory vessel inserts can be transported automatically and/or manually to the workstation 8 by means of a robotic gripper 9 (FIG. 4), and the laboratory vessel inserts can also be transported individually, that is to say they can be taken out of, and inserted into, the frame.

The laboratory vessel inserts 12 to 22 in the carrier frame 4 in accordance with FIG. 1, as well as a number of laboratory vessel inserts 24, 26 and 28, which are not illustrated in FIG. 1, are illustrated in FIG. 2 and also in respectively three different views in FIGS. 5 to 13. It can be seen that the laboratory vessel inserts 12 to 28 are in each case designed as temperature-control modules by each having a body 30 composed of aluminum which ensures a uniform temperature distribution when the planar underside 32 of the storage system 2 in accordance with FIG. 1 is placed onto a temperature-control device, for example onto the temperature-control device 34 of the workstation 8 in accordance with FIG. 3. The bodies 30 of the inserts 12 to 28 composed of thermally conductive material surround the respective vessels (not all parts shown) of each of the inserts 12 to 28 at least in part and thus feed the temperature of the temperature-control device 34 into the liquid which is accommodated by the respective vessel. So that the temperature is fed uniformly from the temperature-control device 34 into the vessels via the planar underside 32, each body 30 is planar on its underside, and the underside of the body 30 of each of the inserts, which are inserted in the carrier frame 4, in each case slightly protrude from the frame 4 so that the inserts 12 to 22 are slightly lifted by the temperature-control surface of the temperature-control device 34 and the own weight of the inserts aid the temperature-control contact. If the frame 4 is consequently placed in the temperature-control device 34 (and there in particular on the planar temperature-control surface 34) in an interlocking manner by means of the corners 6 on the underside of the frame, then the planar undersides 32 of the bodies 30 of the inserts 12 to 28 first of all engage with the temperature-control surface 34, before the interlocking corners 6 then secure the entire arrangement of the storage system 2 in an interlocking fashion in the corresponding corner-mounts of the temperature-control device 34.

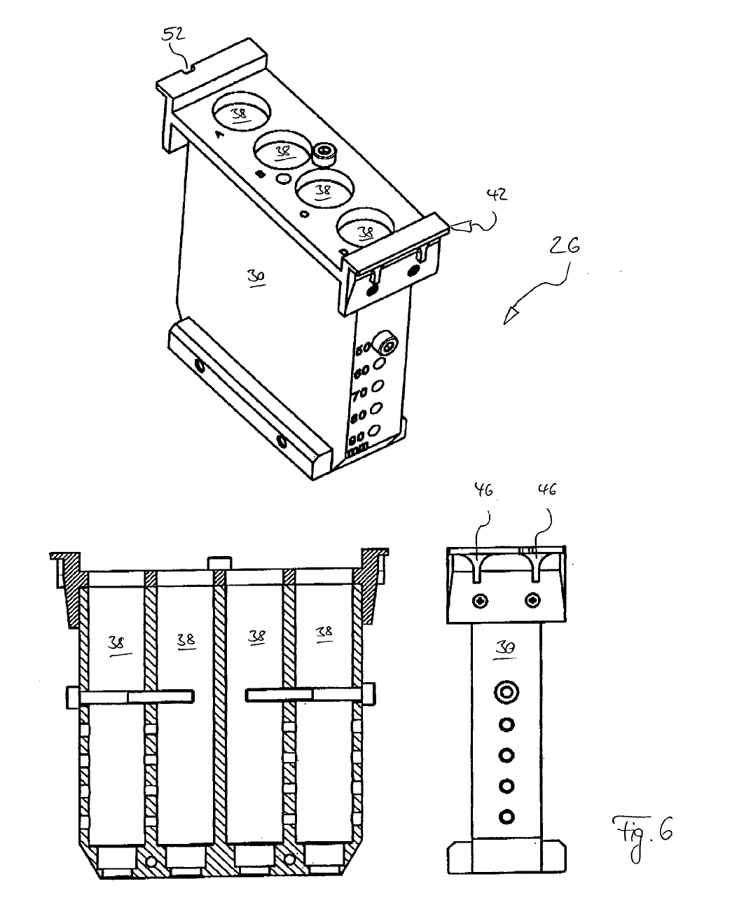

As mentioned previously, each of the laboratory vessel inserts 12 to 28 in accordance with FIG. 2 contains at least one compartment 38 for a particular laboratory vessel 40: from left to right in FIG. 2, the insert 24 (cf. also FIG. 5) has two circular compartments 38 for cylindrical, large-volume vessels. One of these vessels 40 is illustrated in the insert 24 in FIG. 2. The inserts 26, 14, 16 and 18 in each case have four compartments (cf. also FIGS. 6 to 9) which are likewise for cylindrical laboratory vessels, although these are narrower than in the case of insert 24. It can be seen that both insert 24 and insert 26 require, due to the relatively large diameter of their compartments 38, a width of the inserts 24 and 26 which has double the size compared to the remaining inserts 12 to 22 and 28. Inserts 20 and 22 in each case have compartments 38 for eight laboratory vessels, which are likewise cylindrical vessels to be precise, whereas, finally, inserts 12 and 28 have compartments for a low (12) or high (28) tub 40. In particular in the case of the high tub 40 of the insert 28, it is advantageous that the inserts in accordance with FIG. 1 are arranged tightly packed in a row, adjacent to one another in the carrier frame 4, because in this fashion the tub container 40 of an insert 28 is also heated by the temperature-control body 30 of a neighboring insert.

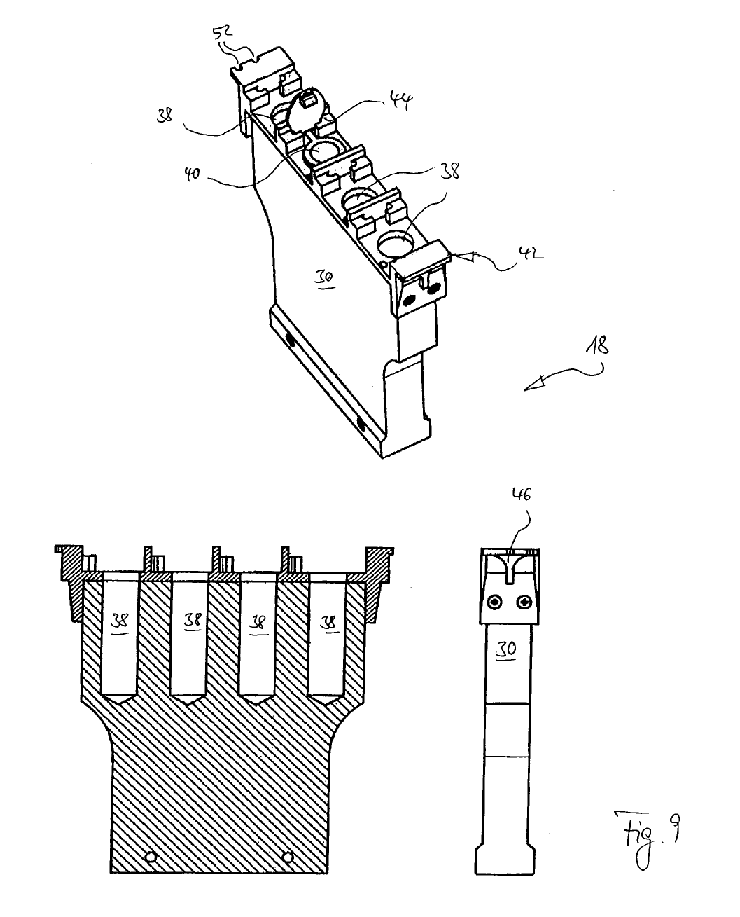

Some of the inserts (18 to 22) have, on the top of their respective multi-functional insertion aid 42, cover fixing webs 44, which are able to keep the integral hinge covers, for example of the vessel 40 in the insert 22, in a cover position, pivoted out by 90° (i.e. pointing vertically upward) . In FIGS. 1 and 2, the integral hinge cover of vessel 40 in the insert 22 is illustrated in a closed state; in FIG. 9 (top), the integral hinge cover of the vessel 40 in the insert 22 is opened in the position pointing 90° vertically upward by means of the cover fixing web 44.

Each of the slots 10 in the carrier frame 4 in accordance with FIG. 1 has a Y-shaped notch on both sides at the upper edge of the carrier frame 4, in which at least one positioning lug 46 of the respective insert 12 to 28 is held in an interlocking manner. The Y-shaped notches limit the sides of sheet-metal tongues 48 of the upper edge of the carrier frame 4. On the side of FIG. 1 facing the observer, the sheet-metal tongues are only as high as the Y-shaped notches 46, whereas on the opposite side, facing away from the observer in FIG. 1 (covered in FIG. 1 by inserts 12 to 22), their height is extended to the resilient tongues by vertical cuts in the sheet-metal wall 4 which extend the Y-shaped notches 46 downward. These spring tongues (not illustrated) clamp each of the inserts 12 to 22 in FIG. 1 in the direction of the observer against the tongues 48 of the front wall of the carrier frame 4, this front wall thus forming an aligned reference line in order to be able to position the respective compartments of the inserts 12 to 22 in a very precise manner.

The carrier frame 4 has a further Y-shaped notch 50 along one of the two narrow sides (along the right-hand narrow side in FIG. 1), which makes a 180° rotation of the frame in, for example, the interlocking mount of the temperature-control device 34 of the workstation 8 optically detectable. Inserts 12 to 28 also have on one of the two narrow sides of the respective multi-functional insertion aid 42 coding notches 52 which make it possible to unambiguously detect the type of the respective laboratory vessel insert by means of their unambiguous position. It is also possible for a suitable, e.g. optical, sensor to identify by means of the notch 52 whether the insert has possibly been inserted into the carrier frame 4 with 180° rotation.

1. A modular storage system for laboratory liquids, characterized in that a carrier frame has a certain number of slots for at least two different laboratory vessel inserts which can be inserted in an interlocking manner into the slots of the carrier frame such that they can be interchanged and combined arbitrarily and which respectively have at least one laboratory vessel and/or at least one compartment for at least one laboratory vessel.

2. The system as claimed in claim 1, characterized in that the inserts arrange the vessels in a rectangular field in the frame when said inserts are inserted into the frame.

3. The system as claimed in one of the preceding claims, characterized in that the slots are arranged in a row, adjacent to one another.

4. The system as claimed in one of the preceding claims, characterized by at least one spring element which clamps the insert in respectively one slot.

5. The system as claimed in the preceding claim, characterized in that the spring element laterally clamps the insert against a reference line which is aligned with all the slots.

6. The system as claimed in one of the two preceding claims, characterized in that the frame has at least one spring element for each slot.

7. The system as claimed in one of the preceding claims, characterized in that the compartment has a mold element which locks the cover of an inserted laboratory vessel in an open position.

8. The system as claimed in one of the preceding claims, characterized in that the inserts can be inserted into the frame such that they can be rotated by 180°, and in that the frame and/or the inserts have a marking which makes it possible to detect, in particular by optical means, a rotation by 180°.

9. The system as claimed in one of the preceding claims, characterized in that the insert has a coding which makes it possible to detect, in particular by optical means, the type and/or even the presence of the insert and/or the at least one laboratory vessel.

10. The system as claimed in one of the preceding claims, characterized in that the insert can be coded so that at least one property of the at least one laboratory vessel, in particular relating to its contents, can be detected, in particular by optical means.

11. The system as claimed in one of the preceding claims, characterized in that the inserts have a body comprising a thermally conductive material which at least in part surrounds the at least one vessel.

12. The system as claimed in the preceding claim, characterized in that the body is planar on its underside, and in that the undersides of the bodies of the inserts, which are inserted in the frame, together form a planar underside.

13. The system as claimed in one of the preceding claims, characterized in that on the underside the frame has the standard format SBS of a microplate.

14. The system as claimed in one of the preceding claims, characterized in that the frame is bent from sheet metal and surrounds the slots.

15. The system as claimed in one of the preceding claims, characterized in that the carrier frame with the inserted laboratory vessel inserts and/or the laboratory vessel inserts, can be individually transported, automatically and/or manually, in a workstation by means of suitable apparatuses, in particular by means of a robotic gripper.
